(19) United States
(12) Patent Application Publication
(10) Pub. No.: US 2025/0236532 A1
(43) Pub. Date: Jul. 24, 2025

(54) PROCESS OF EXTRACTING DELETERIOUS SUBSTANCES, AND PRODUCT OBTAINED THROUGH THE PROCESS OF EXTRACTING DELETERIOUS SUBSTANCES

(71) Applicant: Vale S.A., Rio de Janeiro (BR)

(72) Inventors: Ruberlan GOMES DA SILVA, Belo Horizonte (BR); Danielly Juliana FIGUEIREDO COUTO, Belo Horizonte (BR)

(21) Appl. No.: 19/054,586

(22) Filed: Feb. 14, 2025

(30) Foreign Application Priority Data
Feb. 19, 2024 (BR) 102024003232-2

(51) Int. Cl. C01G 3/12; C22B 3/08; C22B 3/22; C22B 3/44

(52) U.S. Cl. CPC C01G 3/12; C22B 3/08; C22B 3/22; C22B 3/44

(57) ABSTRACT

The present disclosure relates to a process of extracting deleterious substances from ore concentrates, preferably copper sulfides, with the aim of reducing the content of certain deleterious substances such as fluoride, uranium and/or thorium in said concentrates. The process comprises at least an acid leaching step and a step to reduce the internal residual acidity of the leached ore concentrate. The disclosure also refers to the physicochemical quality of the product obtained by this process route.

### CROSS REFERENCE TO RELATED APPLICATION

This application claims the benefit of priority to Brazilian patent application Ser. No. 102024003232-2, filed Feb. 19, 2024, the disclosure of this application is hereby incorporated by reference in its entirety.

### FIELD

The present invention falls within the field of mining and deals with a process of extracting deleterious substances with the aim of reducing the content of certain contaminants such as uranium, fluoride and/or thorium in copper sulfide concentrates. The invention also refers to the physicochemical quality of the product obtained by this process route.

### BACKGROUND

In the field of mining, the copper sulfide concentrates obtained generally have impurities, or deleterious substances, which affect the quality of the product. A copper sulfide concentrate, for example, containing bornite (Cu₅FeS₄) or chalcocite (Cu₂S) as copper-bearing minerals, can have typical contents of 38% Cu, 13% S, 14% Fe, as well as impurities such as fluoride (F=1800 ppm) and uranium (U=27 ppm), while a copper sulfide concentrate containing chalcopyrite (CuFeS₂) as the main copper mineral can have typical contents of 30% Cu, 30% S, 25% Fe, as well as impurities such as fluoride (F=650 ppm) and uranium (U=120 ppm). Above certain levels, for example F>1000 ppm in the case of the Chinese market, these impurities are liable to penalties, and very high levels of uranium and thorium can even lead to a restriction on the marketing of the product. In addition, the product obtained after reducing the deleterious contents through acid leaching must exhibit satisfactory stability to guarantee the physicochemical quality of the leached copper sulfide concentrate during its subsequent transportation, storage and use.

Conventionally, the state of the art includes efforts to extract deleterious substances from copper sulfide concentrates using different process routes that achieve a significant reduction in deleterious content, including, for example, hydro metallurgical routes.

The document “Kinetics of uranium leaching process using sulfuric acid for Wadi Nasib ore, South western Sinai, Egypt” by M. M. Rashad, S. A. Mohamed, E. M. E L sheikh, H. E. Mira, G. M. Abd el Wahab and S. A. Zaki reveals a study on the leaching of uranium from an ore using sulfuric acid solution. However, this document considers acid leaching of oxidized ores at a high temperature (80° C.) and such leaching is not selective, i.e. there is leaching of copper that requires subsequent recovery, making the process more costly. In addition, a step to eliminate residual acidity is not considered to guarantee the physicochemical quality of the leached concentrate during transportation, storage and use.

The document “Selective leaching of penalty elements from copper concentrates: A review” by Daniel J. Lane, Nigel J. Cook, Stephen R. Grano and Kathy Ehrig reveals several leaching systems that have been developed for the selective extraction of elements that pay penalties in the commercialization of the respective copper sulfide concentrates, including: alkaline sulfide leaching (ASL); sodium hypochlorite leaching; sulfuric acid diluted with aluminum sulfate leaching; and combined pressure oxidation leaching (POX) with copper precipitation leaching. However, none of the proposed routes present a combination of leaching at room temperature, using a low-cost acid that is easy to obtain on the market (H₂SO₄), without extracting copper, and using simple equipment such as agitated tanks, thickeners and filters. In addition, a step to eliminate residual acidity is not considered to guarantee the physicochemical quality of the leached concentrate during transportation, storage and use.

As explained above, there are efforts in the state of the art dedicated to deleterious substances extracting processes from ore concentrates using different methods. However, there remains a lack of a process route based on acid leaching that is thermally efficient, low cost, that achieves a high rate of elimination of deleterious substances, mainly uranium, fluoride and/or thorium, but without the extraction of metals that need to be subsequently recovered, that uses simple equipment and presents a step of elimination of residual acidity to guarantee the physical-chemical quality of the leached concentrate during transportation, storage and use.

As will be more fully detailed below, the present invention aims to solve the problems of the state of the art described above in a practical and efficient way.

### SUMMARY

The present invention relates to a process for extracting deleterious substances, mainly uranium, fluoride and/or thorium, from copper sulfide concentrates. The presence of such impurities in concentrates is subject to penalties, and very high levels of uranium and thorium can even lead to a restriction on the marketing of the product.

The invention also refers to the product obtained by this process, which has satisfactory stability, guaranteeing the physical-chemical quality of the leached concentrate during its subsequent transportation, storage and use.

The objectives and other advantages of the present invention will become clearer from the following description.

### BRIEF DESCRIPTION OF THE FIGURES

FIG. 1 illustrates the extraction of copper, fluoride and uranium according to examples 1 to 7 using the process of the present invention, from copper sulfide concentrate containing bornite and chalcocite as the main minerals carrying this metal.

FIG. 2 illustrates the extraction of copper, fluoride and uranium according to examples 1 to 7 using the process of the present invention, from copper sulfide concentrate containing chalcopyrite as the main copper-bearing mineral.

FIG. 3 illustrates the extractions of copper, fluoride and uranium according to examples 8 to 12 using the process of the present invention, as a function of the concentration of Al₂(SO4)₃ in the leaching solution.

FIG. 4 illustrates the extractions of copper, fluoride and uranium according to examples 9, 13 and 14 using the process of the present invention, as a function of residence time.

FIG. 5 illustrates a first route option for the process of extracting deleterious substances of the present invention involving two solid-liquid separation steps using thickeners and filter presses.

FIG. 6 illustrates a second route option for the process of extracting deleterious substances of the present invention involving counter-current washing of the leached copper sulfide concentrate and a single solid-liquid separation step using a thickener and filter presses.

### DETAILED DESCRIPTION

Copper sulfide concentrates can have fluoride and uranium contents above their typical values, with average values of 2,500 ppm F and 60 ppm U. Above certain levels, for example F>1000 ppm in the case of the Chinese market, these impurities are liable to penalties, and very high levels of uranium can even lead to restrictions on the marketing of the product.

It is therefore necessary to develop process routes that can selectively reduce the impurity content of the concentrate to increase profitability by not paying penalties, as well as opening the market through the possibility of selling a product with lower levels of F, U and/or Th on the world market. This product must also have satisfactory stability, guaranteeing the physical and chemical quality of the leached concentrate during its subsequent transportation, storage and use.

In order to solve the technical problems described above, the present invention provides a process for the selective extraction of deleterious substances from ore concentrates, preferably copper sulfide, comprising at least the following steps: i) subjecting the ore concentrate to acid leaching to obtain the leached ore concentrate with reduced deleterious content and a leaching liquor; and ii) subjecting the leached ore concentrate resulting from step i) to a process for reducing the internal residual acidity through washing with process water and/or neutralization with the addition of hydrated lime pulp.

According to the present invention, the raw material fed to said process consists of sulfide copper concentrate, with about 55% to 60% solids, coming from the underflow of the thickener of the processes for producing copper sulfide concentrates by flotation. This copper sulfide concentrate can contain chalcopyrite (CuFeS₂), bornite (Cu₅FeS₄), chalcocite (Cu₂S), enargite (Cu₃AsS₄) and/or covellite (CuS). The deleterious substances extracted are preferably fluoride, uranium and/or thorium.

The acid leaching step is carried out preferably using sulfuric acid and/or aluminum sulfate solutions, with pH adjustment between about 1.5 and about 4.0, preferably with pH between about 2.5 and about 3.5. The acid leaching step is conducted with a residence time ranging from about 2 to about 8 hours, preferably about 6 hours, a temperature of about 15° C. to about 35° C., preferably between about 15° C. and about 25° C., and a solids content of about 10% to about 30%, preferably about 20%. The acid leaching step can be carried out using concentrated sulfuric acid (98% m/m) and/or the addition of aluminum sulfate to achieve a concentration of about 10 g/L to about 30 g/L, preferably about 15 g/L, of Al₂(SO₄)₃ in the leaching liquor. The use of aluminum sulfate is recommended when you want to reduce the fluoride content of copper sulfide concentrate containing fluorite (CaF₂) as a carrier mineral for this element, while lower pH is recommended to reduce the uranium and/or thorium content of copper sulfide concentrate containing uraninite (UO₂) and/or thorite (ThO₂) as carrier minerals for these elements. Aluminum ions (Al³⁺), generated by the chemical dissociation of aluminum sulfate, complex with fluoride ions (F), forming very stable, water-soluble complexes (AlF₆³⁻) and are eliminated in the liquid effluent.

After this step, a leached copper sulfide concentrate and a leaching liquor are obtained. In this process route, fluorite (CaF₂), uraninite (UO₂) and/or thorite (ThO₂), the main minerals carrying fluorine, uranium and/or thorium, are selectively leached and removed from the product, which is the leached copper sulfide concentrate. The process route does not reduce the chloride content in the leached copper concentrate because this element is contained in the crystal structure of silicates and phosphates, such as biotite, amphiboles, scapolite, ferropyrosmalite and apatite, minerals that require more aggressive acid leaching conditions to be leached (pH<1).

This acid leaching step takes place at room temperature and therefore requires no heating or energy consumption. The processing conditions were optimized to ensure low reagent consumption. Additionally, there is no significant extraction of copper, a maximum of 0.50% of the total mass of copper fed into the copper sulfide concentrate, into the leaching liquor during processing, the leaching liquor may also be copper-free or with a very low concentration of this metal, thus not requiring the recovery of this metal in a later step, for example, by cementation with iron filings.

The acid leaching step of the present invention has a simple construction concept because it can use equipment such as tanks, agitators, thickeners, slurry pumps and filter presses, which operate at room temperature.

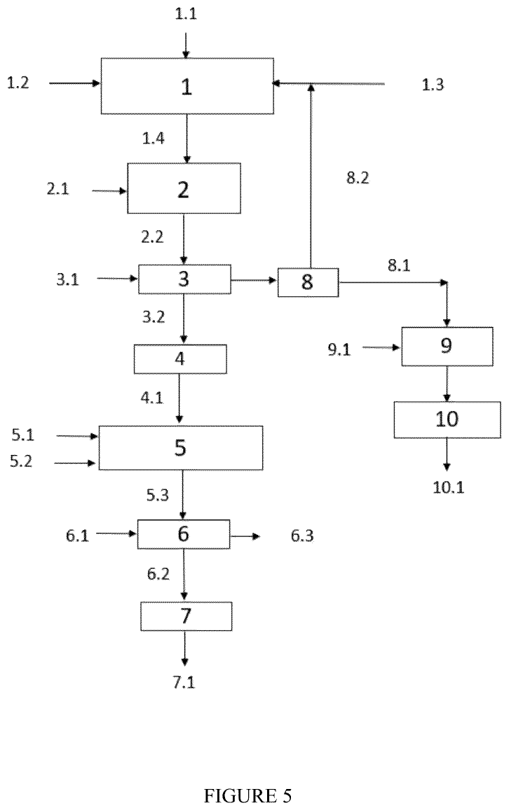

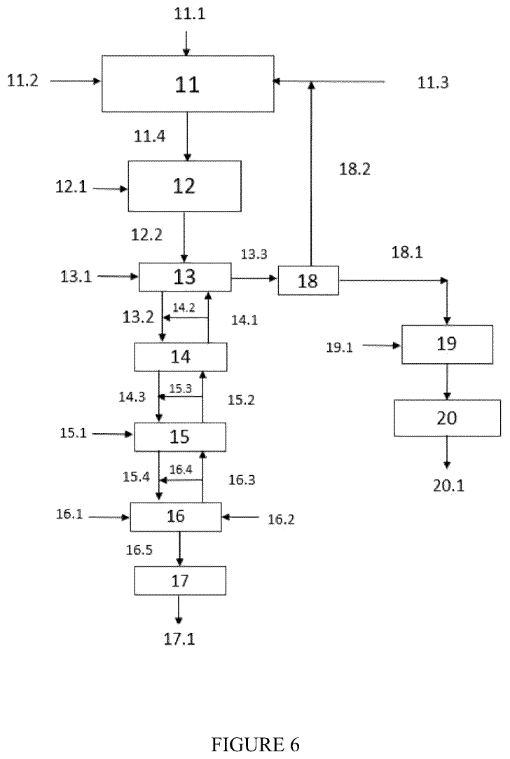

The majority (60% to 80%) of the leaching liquor generated in step i) of the double filtration process route (FIG. 5) is recycled to the acid leaching step. This guarantees the reuse of water, a reduction in reagent consumption and the generation of waste containing fluoride, uranium and/or thorium in the liquid effluent treatment step. While the remainder of the leaching liquor, between 20% and 40%, generated in step i) is purged and treated to eliminate fluoride, uranium and/or thorium through precipitation with hydrated lime and, consequently, generating a solid residue rich in fluoride, uranium and/or thorium, which is subsequently drained and disposed of in accordance with its environmental classification. The treated leaching liquor can be returned to the leaching step. In the case of the process route with counter current washing (FIG. 6), the proportion of recycled liquor for the acid leaching step varies between 20% and 40% of the total generated, while the remainder, between 60% and 80%, will need to be purged and treated to eliminate fluoride, uranium and/or thorium through precipitation with hydrated lime and, consequently, with greater generation of solid waste rich in fluoride, uranium and/or thorium, which is subsequently drained and disposed of in accordance with its environmental classification. The treated leaching liquor can be returned to the leaching step of this process route.

After the acid leaching step of the present invention, the results indicated fluoride and uranium extraction ranging from 10% to 60% and from 30% to 50%, respectively. The radioactivity before and after leaching the concentrate was measured with a GEIGER counter and the result indicated that the process route can reduce the uranium content and keep the level of radioactivity unchanged (<1 mSv/year) in the leached copper sulfide concentrate.

The leached copper sulfide concentrate obtained has lower levels of fluoride, uranium and/or thorium, but contains internal residual acidity that needs to be removed to avoid loss of physicochemical quality during transportation, storage and use. Due to the internal residual acidity, the stability of the leached copper sulfide concentrate was not satisfactory during storage, as it was highly heated (temperature >60° C.), high levels of oxidation (soluble Cu/total Cu>10%), high moisture loss (final humidity of 0.15%) and the formation of high mechanical strength lumps (Iₛ₍₅₀₎₌0.94 MPa). This loss of physicochemical quality was caused by the oxidation reactions of the sulfides that occurred when the leached, wet copper sulfide concentrate (9% to 11% m/m moisture) was exposed to the weather. Sulfide oxidation reactions are enhanced in acidic media. It is industry practice to produce, store and transport sulfide copper concentrates with moisture contents of between 9% and 11% m/m. These data show the importance of eliminating internal residual acidity to guarantee the stability of the physicochemical quality of the leached copper sulfide concentrate during storage, transportation and use.

Thus, the leached copper sulfide concentrate then goes through a step of reduction of internal residual acidity, which preferably consists of washing with process water and/or neutralization with the addition of hydrated lime pulp until the pH of the pulp reaches values between 6.5 and 7.5, preferably pH close to 7.0, under suitable conditions such as a temperature of about 15° C. to 35° C., preferably at room temperature (about 20° C.), with solids content ranging from about 20% to about 50% m/m, preferably between about 20% and about 40% m/m, with residence time ranging from about 15 minutes to about 45 minutes, preferably about 30 minutes, and agitation speed suitable for keeping the solids in suspension.

After the internal residual acidity reduction step, the final product is obtained, which presents a reduction in the fluoride content between about 10% and about 60%, a reduction in the uranium content between about 30% and about 50% and/or a reduction in the thorium content between about 30% and about 50%, as well as satisfactory stability properties for its storage, transport and use, and can then be commercialized.

The present invention, through the combination of the acid leaching steps and the process for reducing the residual acidity of the leached copper concentrate, presents advantages, since the aforementioned reduction obtained in the fluoride, uranium and/or thorium content of sulfide copper concentrates reduce the payment of penalties and allows new markets to be opened up. This process takes place selectively without the extraction of copper, with low reagent consumption, no need for heating and little generation of solid waste with high levels of fluoride, uranium and/or thorium. It is a process route with low capital and operating costs and uses simple equipment such as tanks, thickeners and filter presses.

The present invention also relates to the product obtained through this process, which has a reduction in fluoride content of between about 10% and about 60%, a reduction in uranium content of between about 30% and about 50% and/or a reduction in thorium content of between about 30% and about 50%. It is free of residual acidity and has satisfactory stability properties for storage, transportation and use, and can therefore be marketed. The physicochemical stability was confirmed through tests with samples of unleached copper sulfide concentrates and after being subjected to the leaching step with sulfuric acid, where the product of this invention presented a low content of copper soluble in acetic acid (<10% soluble Cu/total Cu), without formation of lumps of high mechanical resistance and without excessive loss of moisture during storage for a period of 60 days under controlled atmospheric conditions.

The description that has been given so far of the object of the present invention should be considered only as a possible embodiment or embodiments, and any characteristics introduced therein should be understood only as something that has been written to facilitate understanding. Therefore, they should not be considered as limiting the invention, which is limited to the scope of the claims.

The examples that will be presented illustrate the scope of the product generated through the process proposed herein.

### EXAMPLES

Bench tests were carried out to demonstrate the effect of this process on the extraction of deleterious substances from ore concentrates under different conditions.

### Examples 1 to 7

Firstly, tests were carried out on bornite/chalcocite and chalcopyrite sulfide copper concentrates. The solids content in the pulp was 20% and the leaching was carried out without heating. Tests were carried out on 7 examples, with different conditions for the concentration of the Al₂(SO₄)₃ solution in the leaching liquor (g/L), the pH of the liquor and the leaching time. Table 1 illustrates these conditions for examples 1 to 7.

TABLE 1
LEACHING CONDITIONS OF BORNITIC/CHALCOCYTIC
AND CHALCOPYRITIC SULFIDE COPPER CONCENTRATES
(20% PULP SOLIDS CONTENT AND LEACHING
WITHOUT PULP HEATING)

| | Concentration of | | |
|---|---|---|---|
| | Al₂(SO₄)₃ solution in the | | Leaching time |
| Example | leaching liquor (g/L) | Liquor pH | (h) |
| 1 | 15.0 | 3.5 | 6 |
| 2 | 15.0 | 1.5 | 6 |
| 3 | 5.0 | 3.5 | 6 |
| 4 | 5.0 | 3.5 | 3 |
| 5 | 0.0 | 3.5 | 6 |
| 6 | 0.0 | 1.5 | 6 |
| 7 | 0.0 | 3.5 | 3 |

FIG. 1 illustrates the extraction of copper, fluoride and uranium from copper sulfide concentrate containing bornite and chalcocite as the main metal-bearing minerals. These are examples of the process of extracting deleterious substances of the present invention, depending on the concentration of Al₂(SO₄)₃ in the leaching solution, the pH of the liquor and the leaching time at room temperature. Table 1 describes the conditions of the sulfuric acid leaching tests carried out on copper sulfide concentrate containing bornite and chalcocite as the main copper-bearing minerals. The best extraction condition was obtained in Example 1, with copper extraction of only 4%, uranium extraction of 43% and fluoride extraction of 54%, at pH 3.5 and a concentration of 15 g/L of Al₂(SO₄)₃ in the liquor.

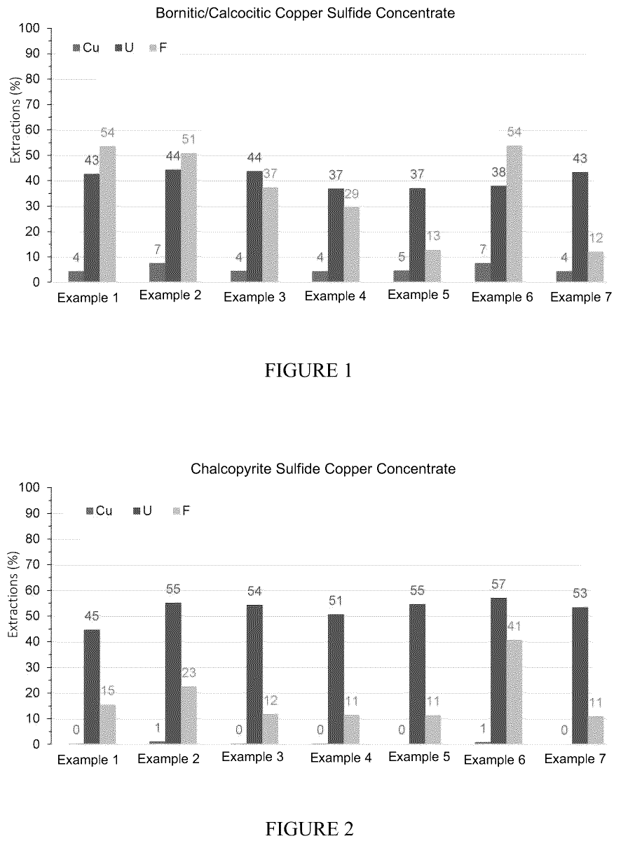

FIG. 2 illustrates the extraction of copper, fluoride and uranium from copper sulfide concentrate containing chalcopyrite as the main metal-bearing mineral. These are examples of the process of extracting deleterious substances of the present invention, depending on the concentration of Al₂(SO₄)₃ in the leaching solution, the pH of the liquor and the leaching time at room temperature. The best extraction condition was obtained in Example 6, with copper extraction of close to 0%, uranium extraction of 57% and fluoride extraction of 41%, at pH 1.5 and without the addition of Al₂(SO₄)₃.

In addition, another round of bench tests was carried out on the process of the present invention. To carry out these tests, a copper concentrate with values of Cu (˜38%), F (˜1500 ppm), Cl (˜1000 ppm) and U (˜60 ppm) was used. The Cu/S mass ratio was 2.72, indicating the presence of chalcocite and bornite in the mineralogical composition of the copper sulfide concentrate used. The sulfide, sulfate and sodium sulfur contents in the copper concentrate were 12.87%, <0.61% and 0.061%, respectively. The mass ratio of sulfide sulfur to total sulfur was 0.91, indicating, as expected, that more than 90% of the sulfur is in the form of sulfides. The sulfur content in the form of sulfate was less than 0.61%, which is also an indication that the sample was not oxidized. The particle density determined in a pycnometer was 4.073 g/cm³, the average diameter (d₅₀) of the particles was 16 μm and 80% of them were smaller than 38 μm (P₈₀).

The mineralogy of the copper concentrate used was also carried out. The main minerals were bornite (31.9%), chalcocite/digenite (23.2%), amphiboles (8.7%), chlorite (6.8%), biotite/stilpnomelane (5.5%), quartz (5.4%), CuS/ganga (4.8%), iron oxide-hydroxides (4.5%) and chalcopyrite (4.1%), accounting for 95% of the mass. The following contents were found in the copper concentrate: 38.20% Cu, 14.02% S, 15.06% Fe, 8.95% Si, 1543 ppm F and 960 ppm Cl. It can be seen that 50% and 46% of the copper comes from bornite and chalcocite/digenite respectively, while 55%, 32% and 10% of the sulfur comes from bornite, chalcocite/digenite and chalcopyrite respectively. Iron is distributed in various minerals, the main ones being bornite, iron oxide-hydroxides and amphiboles/greenalite. Silicon comes from quartz, amphiboles/greenalite, chlorite and other minerals. Fluorite is the main source of fluorine, which occurs in smaller proportions in biotite/stilpnomelane and apatite. Around 70% of the chloride is contained in biotite/stilpnomelane.

### Example 8

Firstly, acid leaching tests (sulfuric acid and aluminum sulfate) were carried out to reduce the fluoride and uranium content in the copper concentrate used. Acid leaching was carried out under the following process conditions: pH 3.5 (20° C.) adjusted with the addition of concentrated sulfuric acid (98% m/m), a solids content of 20%, leaching at room temperature, without the addition of aluminum sulfate and a leaching time of 6 hours. After this step, the uranium content in the leached copper concentrate was 43.93 ppm (27.90% extraction) and the fluoride content in the leached copper concentrate was 1428 ppm (11.18% extraction).

### Example 9

Acid leaching was carried out under the following process conditions: pH 3.5 (20° C.) adjusted with addition of concentrated sulfuric acid (98% m/m), solids content of 20%, leaching at room temperature, with addition of aluminum sulfate to reach a concentration of 15 g/L of Al₂(SO₄)₃ in the leaching liquor and a leaching time of 6 hours. After this step, the uranium content in the leached copper concentrate was 48.37 ppm (25.53% extraction) and the fluoride content in the leached copper concentrate was 732 ppm (45.24% extraction).

### Example 10

Acid leaching was carried out under the following process conditions: pH 3.5 (20° C.) adjusted with addition of concentrated sulfuric acid (98% m/m), solids content of 20%, leaching at room temperature, with addition of aluminum sulfate to reach a concentration of 20 g/L of Al₂(SO₄)₃ in the leaching liquor and a leaching time of 6 hours. After this step, the uranium content in the leached copper concentrate was 47.69 ppm (28.75% extraction) and the fluoride content in the leached copper concentrate was 687 ppm (43.29% extraction).

### Example 11

Acid leaching was carried out under the following process conditions: pH 3.5 (20° C.) adjusted with addition of concentrated sulfuric acid (98% m/m), solids content of 20%, leaching at room temperature, with addition of aluminum sulfate to reach a concentration of 25 g/L of Al₂(SO₄)₃ in the leaching liquor and a leaching time of 6 hours. After this step, the uranium content in the leached copper concentrate was 43.59 ppm (29.13% extraction) and the fluoride content in the leached copper concentrate was 696 ppm (45.44% extraction).

### Example 12

Acid leaching was carried out under the following process conditions: pH 3.5 (20° C.) adjusted with the addition of concentrated sulfuric acid (98% m/m), 20% solids content, leaching at room temperature, with the addition of aluminum sulfate to reach a concentration of 30 g/L of Al₂(SO₄)₃ in the leaching liquor and a leaching time of 6 hours. After this step, the uranium content in the leached copper concentrate was 41.43 ppm (26.07% extraction) and the fluoride content in the leached copper concentrate was 782 ppm (39.97% extraction).

### Example 13

Acid leaching was carried out under the following process conditions: pH 3.5 (20° C.) adjusted with addition of concentrated sulfuric acid (98% m/m), solids content of 20%, leaching at room temperature, with addition of aluminum sulfate to reach a concentration of 15 g/L of Al₂(SO₄)₃ in the leaching liquor and a leaching time of 2 hours. After this step, the uranium content in the leached copper concentrate was 53.77 ppm (16.80% extraction) and the fluoride content in the leached copper concentrate was 1073 ppm (23.82% extraction).

### Example 14

Acid leaching was carried out under the following process conditions: pH 3.5 (20° C.) adjusted with addition of concentrated sulfuric acid (98% m/m), solids content of 20%, leaching at room temperature, with addition of aluminum sulfate to reach a concentration of 15 g/L of Al₂(SO₄)₃ in the leaching liquor and a leaching time of 4 hours. After this step, the uranium content in the leached copper concentrate was 45.91 ppm (21.71% extraction) and the fluoride content in the leached copper concentrate was 825 ppm (36.20% extraction).

Table 2 shows the conditions for the acid leaching tests on the copper concentrate used.

TABLE 2
ACID LEACHING TEST CONDITIONS
FOR COPPER CONCENTRATE

| Identifying | Concentration of aluminum | Leaching time |
|---|---|---|
| the example | sulfate solution (g/L) | (hours) |
| 8 | No addition | 6 |
| 9 | 15 | 6 |
| 10 | 20 | 6 |
| 11 | 25 | 6 |
| 12 | 30 | 6 |
| 13 | 15 | 2 |
| 14 | 15 | 4 |

Table 3 shows the chemical analysis of the leached copper concentrates after the acid leaching step.

TABLE 3
CHEMICAL ANALYSIS OF LEACHED SULFIDE COPPER CONCENTRATES

| | Example | Example | Example | Example | Example | Example | Example |
|---|---|---|---|---|---|---|---|
| Element | 8 | 9 | 10 | 11 | 12 | 13 | 14 |
| Au (g/t) | 15.49 | 16.00 | 16.05 | 16.18 | 16.22 | 15.69 | 15.66 |
| S (%) | 14.04 | 13.93 | 13.91 | 13.60 | 13.75 | 13.89 | 13.66 |
| Cu (%) | 38.48 | 38.25 | 38.35 | 38.02 | 38.50 | 38.16 | 38.43 |
| Na (%) | 0.056 | 0.059 | 0.056 | 0.056 | 0.057 | 0.056 | 0.057 |
| Al (%) | 1.94 | 2.00 | 1.97 | 2.03 | 2.00 | 2.00 | 1.99 |
| Ca (%) | 0.33 | 0.28 | 0.26 | 0.26 | 0.29 | 0.30 | 0.28 |
| Fe (%) | 14.85 | 15.09 | 14.77 | 15.14 | 15.09 | 15.02 | 15.00 |
| Mg (%) | 0.40 | 0.42 | 0.41 | 0.42 | 0.42 | 0.42 | 0.41 |
| Si (%) | 8.72 | 8.74 | 8.52 | 8.83 | 8.78 | 8.76 | 8.72 |
| Th (ppm) | 9.47 | 8.99 | 8.52 | 9.95 | 9.80 | 9.09 | 8.61 |
| U (ppm) | 43.93 | 48.37 | 47.69 | 43.59 | 41.43 | 53.77 | 45.91 |
| F (ppm) | 1428 | 732 | 687 | 696 | 782 | 1073 | 825 |
| Cl (ppm) | 991 | 980 | 877 | 817 | 962 | 849 | 927 |

Table 4 shows the extraction of elements from the sulfide copper concentrate after acid leaching.

TABLE 4
EXTRACTION OF ELEMENTS FROM COPPER
CONCENTRATE AFTER ACID LEACHING

| | Example | Example | Example | Example | Example | Example | Example |
|---|---|---|---|---|---|---|---|
| Element | 8 | 9 | 10 | 11 | 12 | 13 | 14 |
| Au | 0% | 0% | 0% | 0% | 0% | 0% | 0% |
| Cu | 1.11% | 1.40% | 1.32% | 1.38% | 1.29% | 1.12% | 1.37% |
| Ca | 20.12% | 33.43% | 43.77% | 51.52% | 50.86% | 39.60% | 43.47% |
| Fe | 0.59% | 0.57% | 0.94% | 1.01% | 1.03% | 0.63% | 0.56% |
| Mg | 1.38% | 1.14% | 1.39% | 1.35% | 1.35% | 1.19% | 1.16% |
| Yes | 0.16% | 0.12% | 0.15% | 0.16% | 0.16% | 0.11% | 0.11% |
| Th | 0.00% | 1.71% | 2.38% | 2.90% | 2.83% | 1.14% | 1.51% |
| U | 27.90% | 25.53% | 28.75% | 29.13% | 26.07% | 16.80% | 21.71% |
| F | 11.18% | 45.24% | 43.29% | 45.44% | 39.97% | 23.82% | 36.20% |
| Cl | 0.00% | 0.00% | 0.00% | 0.00% | 0.00% | 0.00% | 0.00% |

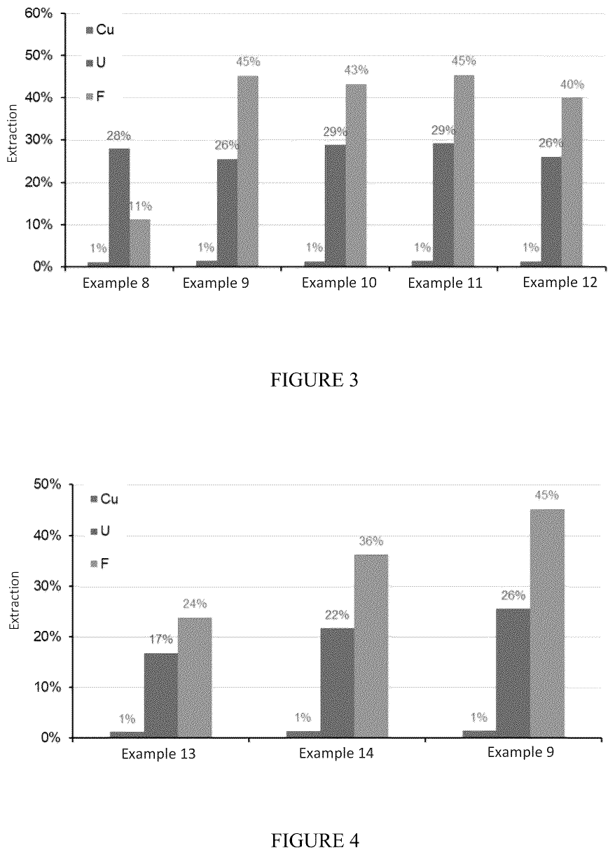

FIG. 3 shows the extractions of copper, fluoride and uranium from the copper concentrate of examples 8 to 12, i.e. as a function of the concentration of Al₂(SO₄)₃ in the leaching solution.

FIG. 4 shows the extractions of copper, fluoride and uranium from the copper concentrate of examples 13, 14 and 9, that is, as a function of residence time.

After these examples, it was found that copper extraction varied very little in all the tests, with an average value of 1.0%. Fluoride extraction was only 11% in Example 8, where no aluminum sulfate was added. At longer residence times, there are greater extractions of F and U, with extractions of 45% of F and 26% of U being obtained with a residence time of 6 hours. Having verified that concentrations of aluminum sulfate greater than 15 g/L in the leaching solution do not impact significant changes in the extractions of Cu, U and F, it was considered that the best leaching condition was that of Example 9, with 15 g/L of aluminum sulfate in the leaching solution and residence time of 6 hours. The leaching pH was approximately 3.5, pulp with 20% solids and without heating. Previous studies using these process conditions have obtained fluoride extractions of between 40% and 73% and uranium extractions of between 10% and 50%.

### Example 15

Tests were then carried out to reduce the internal residual acidity of the leached copper concentrate.

A conical pile containing 15 kg of unleached copper concentrate was used as a reference sample. The pH of this sample was 7.5.

### Example 16

Also used as a reference was a conical pile containing 15 kg of leached copper concentrate, but without the addition of the internal residual acidity reduction step. The acid leaching step followed the parameters considered most appropriate, i.e., pH 3.5 (20° C.) adjusted with the addition of concentrated sulfuric acid (98% m/m), solids content of 20%, leaching at room temperature, with addition of aluminum sulfate to reach a concentration of 15 g/L of Al₂(SO₄)₃ in the leaching liquor and a leaching time of 6 hours. The pH of this sample was 3.5.

### Example 17

A conical pile containing 15 kg of leached copper concentrate was used, whose acid leaching step followed the parameters considered most appropriate, that is, pH 3.5 (20° C.) adjusted with the addition of concentrated sulfuric acid (98% w/m), solids content of 20%, leaching at room temperature, with addition of aluminum sulfate to reach a concentration of 15 g/L of Al₂(SO₄)₃ in the leaching liquor and leaching time of 6 hours. The leached copper concentrate was then repulped with water and 40% solids. The pH of this sample was 4.5.

### Example 18

A conical pile containing 15 kg of leached copper concentrate was used, whose acid leaching step followed the parameters considered most appropriate, that is, pH 3.5 (20° C.) adjusted with the addition of concentrated sulfuric acid (98% w/m), solids content of 20%, leaching at room temperature, with addition of aluminum sulfate to reach a concentration of 15 g/L of Al₂(SO₄)₃ in the leaching liquor and leaching time of 6 hours. The leached copper concentrate was then repulped with water and 40% solids and neutralized with a 10% m/m NaOH solution. The pH of this sample was 7.2.

### Example 19

A conical pile containing 15 kg of leached copper concentrate was used, whose acid leaching step followed the parameters considered most appropriate, that is, pH 3.5 (20° C.) adjusted with the addition of concentrated sulfuric acid (98% w/m), solids content of 20%, leaching at room temperature, with addition of aluminum sulfate to reach a concentration of 15 g/L of Al₂(SO₄)₃ in the leaching liquor and leaching time of 6 hours. The leached copper concentrate was then repulped with water and 40% solids and neutralized with a 10% m/m Ca(OH)₂ (hydrated lime) solution. The pH of this sample was 7.2.

After 60 days, the physicochemical characteristics of samples 15 to 19 were measured. The characteristics of the atmospheric air were: average relative humidity of (81±10) % and average temperature of (16±13)° C. Table 5 shows the values obtained for the physicochemical characteristics of the samples from examples 15 to 19.

TABLE 5
PHYSICOCHEMICAL CHARACTERISTICS OF COPPER CONCENTRATES

| | | | Example 17 | Example 18 | Example 19 |
|---|---|---|---|---|---|
| | | | (leached and | (leached and | (leached and |
| | Example 15 | Example 16 | repulped | neutralized | neutralized |
| | (non-leached) | (leachate only) | with water) | with NaOH) | with Ca(OH)₂) |
| Parameter | pH = 7.5 | pH = 3.5 | pH = 4.5 | pH = 7.2 | pH = 7.2 |
| Initial | 8.0 | 10.7 | 9.8 | 10.0 | 9.9 |
| humidity | | | | | |
| (60° C./24 h) | | | | | |
| Cu content | 38.20 | 37.36 | 37.60 | 37.09 | 37.38 |
| (%) | | | | | |
| Moisture of | 0.98 | 0.41 | 0.14 | 0.28 | 0.14 |
| surface clods | | | | | |
| after 60 days | | | | | |
| (%) | | | | | |
| Mass of | 14 | 18 | 15 | 18 | 2 |
| clods > 2 | | | | | |
| mm (%) | | | | | |
| Soluble Cu | 7.6 | 5.1 | 2.6 | 3.9 | 2.6 |
| EDTA 0.20 | | | | | |
| mol/L/Total | | | | | |
| Cu (%) | | | | | |
| Soluble Cu | 9.1 | 5.9 | 3.2 | 4.4 | 3.1 |
| Acetic Ac. | | | | | |
| 50%/Total | | | | | |
| Cu (%) | | | | | |
| Static | 279 | 307 | 116 | 161 | 480 |
| hardness (gf) | | | | | |
| Iron | 3.3 | 2.5 | 2.5 | 2.4 | 3.8 |
| hydroxides | | | | | |
| containing | | | | | |
| copper (%) | | | | | |

Table 6 shows the moisture content and the content of the main elements in the samples from examples 15 to 19.

TABLE 6
MOISTURE, S, Cu, F, U AND Au CONTENT
OF THE COPPER CONCENTRATES

| | Humidity | Analysis on a dry basis | | | | | |
|---|---|---|---|---|---|---|---|
| Copper | 60° C./24 | S | Cu | F | U | Au | |
| Concentrate | hours (%) | (%) | (%) | (ppm) | (ppm) | (g/t) | Cu/S |
| Example 15 | 7.87 | 14.02 | 38.20 | 1543 | 62.52 | 14.90 | 2.72 |
| Example 16 | 10.70 | 14.50 | 37.36 | 780 | 38.14 | 15.81 | 2.58 |
| Example 17 | 9.77 | 14.37 | 37.60 | 757 | 33.74 | 15.99 | 2.62 |
| Example 18 | 9.98 | 14.23 | 37.09 | 781 | 37.41 | 15.16 | 2.61 |
| Example 19 | 9.89 | 14.09 | 37.38 | 763 | 35.00 | 15.76 | 2.65 |

The moisture content of the leached concentrates was between 9% and 11%, with the copper concentrate sample from Example 19 having the lowest moisture content (9.89%) and the copper concentrate from Example 16 having the highest moisture content (10.70%). The height, diameter and average angle of repose of the 15 kg conical piles were 23 cm, 50 cm and 50° respectively.

Table 7 shows the contents of soluble copper in 0.20 mol/L EDTA solution determined in the initial samples and in the samples collected from the surfaces of the piles of Examples 15 to 19 after 15, 30, 45 and 60 days of exposure to the environment. The soluble copper content was calculated as shown in Eq. (1).

$$( 1 )$$

$$\% Cu soluble = ( mass of copper in the liquor / mass of copper in the initial sample ) \times 100$$

TABLE 7
SOLUBLE COPPER CONTENT IN 0.20 MOL/L
EDTA SOLUTION OF SULFIDE COPPER
CONCENTRATES (VALUES IN % M/M)

| | | Samples collected from the surfaces of the conical | | | |
|---|---|---|---|---|---|
| | | piles | | | |
| Copper | | After 15 | After 30 | After 45 | After 60 |
| Concentrate | Initial | days | days | days | days |
| Example 15 | 4.98 | 6.90 | 6.46 | 7.44 | 7.62 |
| Example 16 | 1.04 | 4.09 | 4.18 | 4.62 | 5.05 |
| Example 17 | 1.26 | 2.25 | 2.40 | 2.42 | 2.58 |
| Example 18 | 1.62 | 3.04 | 2.80 | 3.32 | 3.89 |
| Example 19 | 1.40 | 2.18 | 2.14 | 2.49 | 2.56 |

The initial sample of copper concentrate from Example 15 (non-leached copper concentrate) had a high content of EDTA-soluble copper (5.0% m/m), while the initial samples of the leached concentrates had lower values of soluble copper, on average 1.3% m/m of EDTA-soluble copper.

The greatest increase in EDTA-soluble copper content was seen with Example 16 (copper concentrate only leached), rising from 1.0% m/m in the initial sample to 4.1% m/m after 15 days and reaching 5.0% m/m in 60 days. The lowest levels of soluble copper in EDTA solution were observed in the copper concentrates leached and repulped with water (Example 17) and in the one neutralized with hydrated lime pulp (Example 19). The levels of soluble copper in examples 17 and 19 rose from 1.3% m/m in the initial samples to just 2.5% m/m after 60 days of exposure.

Table 8 shows the levels of copper soluble in 50% m/m acetic acid solution determined in the initial samples and in the samples collected from the surfaces of the piles of examples 15 to 19 after 15, 30, 45 and 60 days of exposure to the environment. The soluble copper content was calculated as shown above in Eq. (1).

TABLE 8
COPPER CONTENT SOLUBLE IN 50% M/M
ACETIC ACID SOLUTION OF COPPER
CONCENTRATES (VALUES IN % M/M)

| | | Samples collected from the surfaces of the conical | | | |
|---|---|---|---|---|---|
| | | piles | | | |
| Copper | | After 15 | After 30 | After 45 | After 60 |
| Concentrate | Initial | days | days | days | days |
| Example 15 | 7.00 | 8.36 | 8.73 | 9.02 | 9.10 |
| Example 16 | 1.95 | 5.17 | 5.40 | 5.77 | 5.89 |
| Example 17 | 2.06 | 2.90 | 3.33 | 3.27 | 3.19 |
| Example 18 | 2.54 | 3.87 | 3.95 | 4.31 | 4.35 |
| Example 19 | 2.14 | 3.07 | 3.07 | 3.19 | 3.13 |

The initial sample of Example 15 (non-leached copper concentrate) had a high content of copper soluble in acetic acid (7.0% m/m), while the initial samples of the leached concentrates had an average of 2.1% m/m of copper soluble in EDTA.

Again, the greatest increase in acetic acid-soluble copper content was seen with Example 16 (copper concentrate only leached), rising from 2.0% m/m in the initial sample to 5.2% m/m after 15 days and reaching 5.9% m/m after 60 days.

Also, for copper soluble in acetic acid solution, the lowest levels were observed in the sulfide copper concentrates leached and repulped with water (Example 17) and in the one neutralized with hydrated lime pulp (Example 19). The soluble copper content in concentrates 3 and 5 rose from 2.3% m/m in the initial samples to 3.2% m/m after 60 days of exposure.

The efficiency of removing residual acidity was proven by monitoring the temperature, soluble copper content and lump formation of the conical piles with the leached concentrates and the washed/neutralized concentrates, as indicated above. The use of sodium hydroxide (NaOH) as a reagent to neutralize residual acidity is not recommended because the pulp containing the leached sulfide copper concentrate and neutralized with the addition of this reagent had a very low sedimentation rate and filtration rate, compromising the performance of the latter step of the solid-liquid separation process route. NaOH is a dispersant, while hydrated lime (Ca(OH)₂) is a binding neutralization reagent, generating a leached and neutralized sulfide copper concentrate with a moisture content above 11% (>13% m/m) and with formation of few, but very resistant, lumps (CaSO₄·2H₂O). The sulfide copper concentrate leached and repulped with water, Example 17, showed the best results in terms of physical and chemical quality after 60 days of storage, with a low soluble copper content (2.6% m/m) and the formation of non-resistant lumps.

In addition, two equipment set options have been proposed for the process of extracting deleterious substances route of the present invention. The first equipment option is shown in FIG. 5 and performs double filtration, with two solid-liquid separation steps, using solid-liquid separation systems with thickeners and filter presses. This option generates less liquid effluent, consumes less hydrated lime, generates less waste containing fluoride, uranium and/or thorium, but operates intermittently due to the use of filter presses.

The sulfide copper concentrate pulp with 55% to 65% solids (1.1) was diluted (1) with 20% solids and acidulated at a pH between 1.5 and 3.5 for 30 minutes without heating, with the addition of 98% m/m sulfuric acid (1.2). A pulp of diluted sulfide copper concentrate with adjusted pH (1.4) was obtained and passed through a leaching tank (2), where leaching took place for 6 hours and without heating, with or without the addition of aluminum sulfate solution (15 g/L of Al₂(SO₄)₃). (2.1).

The pulp from the leached sulfide copper concentrate (2.2) then passed through a thickener I (3) and the overflow from the thickener containing leached sulfide copper concentrate (3.2) passed through a filter press I (4). The leached sulfide copper concentrate with residual acidity (4.1) is then washed or neutralized to reduce the residual acidity (5), using process water (5.1) or hydrated lime pulp (5.2).

The pulp from the leached and washed (neutralized) sulfide copper concentrate (5.3) then passes through a thickener II (6), with the application of a flocculant (6.1). Between 60% and 80% of the overflow from thickener II (6.3) is recycled to the process and the rest is subjected to chemical treatment. The thickener underflow containing leached and washed (neutralized) sulfide copper concentrate (6.2) passed through a filter press II (7) and the final product, leached sulfide copper concentrate free of residual acidity (7.1), was obtained.

Additionally, after thickener I (3), part of the stream passed through a partition (8), in which part of the overflow from thickener I (8.2), between 60% and 80% m/m, was recycled together with process water (1.3) back to step (1) and the other part of the thickener I overflow (8.1), between 20% and 40% went to chemical treatment through neutralization (9) until pH 9.0 with addition of hydrated lime pulp (9.1) and through a filter press III or vacuum filter (10) resulting in a residue containing F, U and/or Th (10.1) which was sent for disposal.

The second equipment set option is shown in FIG. 6 and performs counter-current washing of the leached copper concentrate, with one solid-liquid separation step using thickeners and the leached and washed product is subsequently obtained using filter presses. In counter-current washing, a greater number of thickeners are used compared to the double filtration process route option. This option proves to be more difficult from an operational point of view due to the greater amount of equipment in operation (tanks, pumps, agitators, etc. . . . ), high recirculation flow rates of overflows to dilute the pulps fed into the respective thickeners to guarantee high speeds of solids sedimentation and high hold-up, which requires a longer time to stabilize operational conditions in case of loss of control.

The sulfide copper concentrate pulp with 55% to 65% solids (11.1) was diluted (11) with 20% solids and acidulated at a pH between 1.5 and 3.5 for 30 minutes without heating, with the addition of 98% m/m sulfuric acid (11.2). A pulp of diluted sulfide copper concentrate with adjusted pH (11.4) was obtained and passed through a leaching tank (12), where leaching took place for 6 hours and without heating, with the addition of aluminum sulfate solution (15 g/L of Al₂(SO₄)₃). (12.1).

Next, the leached sulfide copper concentrate pulp (12.2) went through a thickener I (13) with the addition of a flocculant (13.1) and the underflow pulp I (13.2) went through a thickener II (14). Overflow II (14.1) from thickener II (14) returned to thickener I (13) and a recycling (14.2) was generated. This same process was repeated for thickeners III (15) and IV (16), with the addition of flocculants (15.1, 16.1), obtaining underflow II pulp (14.3), underflow III pulp (15.4) and underflow IV pulp (16.5), overflow II (14.1), overflow III (15.2) and overflow IV (16.3), with the presence of recycles (15.3, 16.4) and process water (16.2).

The underflow IV pulp (16.5) was then passed through a filter press (17) and the final product, the leached sulfide copper concentrate free of residual acidity (17.1), was obtained.

In addition, after thickener I (13), overflow I (13.3) went through a partition (18), in which part of the overflow from thickener I (18.2), between 20% and 40% m/m, was recycled together with process water (11.3) back to step (11) and the other part of the overflow from thickener I (18.1), between 60% and 80% went for chemical treatment through neutralization (19) to pH 9.0 with the addition of hydrated lime pulp (19.1) and through a filter press III or vacuum filter (20) resulting in a residue containing F, U and/or Th (20.1) which went for disposal.

Based on the data and information contained in the text, the present invention effectively solves the problem of reducing the deleterious content of copper sulfide concentrates, reducing the payment of penalties levied, opening up new markets and potentially increasing the selling price. The process of the present invention takes place selectively without the extraction of copper, with low consumption of reagents, without the need for heating and with little generation of solid waste with high levels of fluoride, uranium and/or thorium. It is a process route with low capital and operating costs and uses simple equipment such as tanks, thickeners and filter presses.

Numerous variations on the scope of protection of this application are permitted. This reinforces the fact that the present invention is not limited to the configurations/concretizations described above.

1. A process of extracting deleterious substances from ore concentrates, comprising:
i) subjecting an ore concentrate to acid leaching, obtaining a leached ore concentrate and a leaching liquor; and
ii) subjecting the leached ore concentrate resulting from step i) with a reduced deleterious content to an internal residual acidity reduction process by washing with process water and/or neutralization with an addition of hydrated lime pulp,
wherein:
the acid leaching step is conducted with a residence time varying between about 2 hours and about 8 hours, pH between about 1.5 and about 4.0 and temperature between about 15° C. and about 35° C., and
the internal residual acidity reduction process is carried out with a residence time varying between about 15 minutes and about 45 minutes and a temperature between about 15° C. and about 35° C.

2. The process of extracting deleterious substances according to claim 1, wherein a raw material fed to the process consists of sulfide copper concentrate.

3. The process of extracting deleterious substances according to claim 2, wherein the sulfide copper concentrate has about 55% to 60% solids.

4. The process of extracting deleterious substances according to claim 2, wherein the sulfide copper concentrate contains chalcopyrite (CuFeS₂), bornite (Cu₅FeS₄), chalcocite (Cu₂S), enargite (Cu₃AsS₄) and/or covellite (CuS).

5. The process of extracting deleterious substances according to claim 1, wherein the leaching liquor resulting from step i) is free of copper.

6. The process of extracting deleterious substances according to claim 1, wherein the deleterious substances extracted are fluoride, uranium and/or thorium.

7. The process of extracting deleterious substances according to claim 1, wherein the acid leaching step is conducted with the residence time of about 6 hours.

8. The process of extracting deleterious substances according to claim 1, wherein the acid leaching step is conducted at the temperature between about 15° C. and about 25° C.

9. The process of extracting deleterious substances according to claim 1, wherein the acid leaching step is conducted at the pH between about 2.5 and about 3.5.

10. The process of extracting deleterious substances according to claim 1, wherein the acid leaching step is conducted with a solids content of between about 10% and about 30%, preferably about 20%.

11. The process of extracting deleterious substances according to claim 1, wherein the acid leaching step is conducted using sulfuric acid and/or aluminum sulfate.

12. The process of extracting deleterious substances according to claim 11, wherein the aluminum sulfate has a concentration of from about 10 g/L to about 30 g/L, preferably about 15 g/L, of Al₂(SO₄)₃ in the leaching liquor.

13. The process of extracting deleterious substances according to claim 1, wherein the internal residual acidity reduction process is conducted with the residence time of about 30 minutes.

14. The process of extracting deleterious substances according to claim 1, wherein the internal residual acidity reduction process is conducted at room temperature (about 20° C.).

15. The process of extracting deleterious substances according to claim 1, wherein the internal residual acidity reduction process is conducted with a solids content ranging from about 20% to about 50% m/m, preferably from about 20% to about 40% m/m.

16. The process of extracting deleterious substances according to claim 1, wherein a product obtained from the process presents a reduction in a fluoride content between about 10% and about 60%, a reduction in a uranium content between about 30% and about 50% and/or a reduction in thorium content between about 30% and about 50%.

17. The process of extracting deleterious substances according to claim 1, wherein the process is carried out by double filtration, using solid-liquid separation systems using tanks, thickeners, and filter presses.

18. The process of extracting deleterious substances according to claim 17, wherein 60% to 80% of the leaching liquor generated in step i) is recycled to the acid leaching step.

19. The process of extracting deleterious substances according to claim 17, wherein between 20% and 40% of the leaching liquor generated in step i) is purged and treated to eliminate fluoride, uranium and/or thorium through precipitation with hydrated lime, generating a solid residue rich in fluoride and uranium, which is subsequently drained and disposed of in accordance with its environmental classification, and the treated leaching liquor is returned to the acid leaching step.

20. The process of extracting deleterious substances according to claim 1, wherein the process is carried out by counter-current washing, using tanks, thickeners, and filter presses.

21. The process of extracting deleterious substances according to claim 20, wherein 20% to 40% of the leaching liquor generated in step i) is recycled for the acid leaching step.

22. The process of extracting deleterious substances according to claim 20, wherein between 60% and 80% of the leaching liquor generated in step i) is purged and treated to eliminate fluoride, uranium and thorium through precipitation with hydrated lime, generating a solid residue rich in fluoride and uranium, which is subsequently drained and disposed of in accordance with its environmental classification, and the treated leaching liquor is returned to the acid leaching step.

23. A product obtained through a process of extracting deleterious substances as described in claim 1, wherein the product presents a reduction in fluoride content between about 10% and about 60% as compared to the ore concentrate prior to the process, a reduction in uranium content between about 30% and about 50% as compared to the ore concentrate prior to the process and/or a reduction in thorium content between about 30% and about 50% as compared to the ore concentrate prior to the process, and is free of residual acidity.
